(19) United States
(12) Patent Application Publication
(10) Pub. No.: US 2010/0167097 A1
(43) Pub. Date: Jul. 1, 2010

(54) HEAT RECOVERY METHOD AND APPARATUS IN FUEL CELL SYSTEM, AND FUEL CELL SYSTEM INCLUDING THE APPARATUS

(75) Inventors: Jin S. HEO, Suwon-si (KR); Takami Higashi, Suwon-si (KR); Dong-kwan Kim, Hwaseong-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd, Suwon-si (KR)

(21) Appl. No.: 12/579,564

(22) Filed: Oct. 15, 2009

(30) Foreign Application Priority Data
Dec. 26, 2008 (KR) 10-2008-0134968

(51) Int. Cl. H01M 8/04

(52) U.S. Cl. 429/24; 429/26

(57) ABSTRACT

A fuel cell heat recovery system and method, the heat recovery method including: closing a proportionate valve to control water flow to a second heat exchanger that recovers heat from an electric heater that uses surplus power of the fuel cell system, if the fuel cell system is completely activated; opening an electronic valve to control water flow to a first heat exchanger that recovers heat from cooling water discharged from a stack of the fuel cell system; and supplying a predetermined amount of water to the first heat exchanger.

### CROSS-REFERENCE TO RELATED APPLICATION

This application claims the benefit of Korean Patent Application No. 10-2008-0134968, filed on Dec. 26, 2008, in the Korean Intellectual Property Office, the disclosure of which is incorporated herein, by reference.

### BACKGROUND

1. Field

The present teachings relate to heat recovery method and apparatus in a fuel cell system, and a fuel cell system including the apparatus.

2. Description of the Related Art

Generally, a fuel cell is a power generating apparatus that directly converts a fuel into electricity, via a chemical reaction, which continuously generates electricity as long as the fuel is supplied. In a fuel cell system, a fuel gas, a reformed gas formed from the fuel gas, and air move between elements of the fuel cell system. Heat is generated by a reforming reaction in a fuel processor and a chemical reaction of a stack. The heat generated inside the fuel cell system may be recovered, by supplying water stored in a storage tank.

### SUMMARY

One or more exemplary embodiments include a heat recovery method and apparatus in a fuel cell system, which increase heat recovery efficiency in the fuel cell system by effectively cooling a stack of the fuel cell system and effectively recovering heat from an electric heater that uses surplus power generated by a fuel cell.

One or more exemplary embodiments include a fuel cell system including a heat recovery apparatus.

To achieve the above and/or other aspects, one or more exemplary embodiments may include a heat recovery apparatus in a fuel cell system including a fuel processor, a stack, and a power converter. The heat recovery apparatus includes: a storage tank that stores heated water; a pump that discharges water from the storage tank; a first heat exchanger that recovers heat from cooling water discharged from the stack; a second heat exchanger that recovers heat from an electric heater that uses surplus power generated by the fuel cell system; a third heat exchanger that recovers heat from an anode-off gas discharged from the stack, thereby separating liquids from the anode-off gas; a fourth heat exchanger that recovers heat from air discharged from the stack; a fifth heat exchanger that recovers heat from exhaust gas discharged from the fuel processor; an electronic valve that controls the flow of water to the first heat exchanger; a proportionate valve that controls the flow of water to the second heat exchanger; a first thermocouple that measures the temperature of water output from the first heat exchanger; a second thermocouple that measures the temperature of water output from the second heat exchanger; and a third thermocouple that measures the temperature of the third heat exchanger.

According to various embodiments, the pump may supply the water stored in the storage tank to the third heat exchanger, output the water supplied to the third heat exchanger to the fourth heat exchanger, and output the water supplied to the fourth heat exchanger to the fifth heat exchanger. The water supplied to the fifth exchanger may be divided via the proportionate valve and the electronic valve. The water output from the electronic valve may be supplied to the first heat exchanger, and the water output from the first heat exchanger and the water output via the proportionate valve may be combined and supplied to the second heat exchanger.

To achieve the above and/or other aspects, one or more exemplary embodiments may include a fuel cell system including: a fuel processor that reforms a received gas into hydrogen gas (reformate gas); a stack that generates power by using the reformate gas; a power converter that converts direct current (DC) generated by the stack into alternating current (AC); and a heat recovery apparatus that recovers heat generated by the fuel cell system.

To achieve the above and/or other aspects, one or more exemplary embodiments may include a heat recovery method of a fuel cell system including a fuel processor, a stack, and a power converter. The heat recovery method includes: determining whether the fuel cell system is completely activated; if it is determined that the activation of the fuel cell system is completed, closing an electronic valve and completely opening a proportionate valve, in order to control water flow to a second heat exchanger, to recover heat from an electric heater that uses surplus power generated by the fuel cell system; cooling the stack using cooling water; opening the electronic valve to supply water to a first heat exchanger; and supplying a predetermined amount of water to the first heat exchanger.

Additional aspects and/or advantages of the present teachings will be set forth in part in the description which follows and, in part, will be obvious from the description, or may be learned by practice of the present teachings.

### BRIEF DESCRIPTION OF THE DRAWINGS

These and/or other aspects and advantages of the present teachings will become apparent and more readily appreciated from the following description of the exemplary embodiments, taken in conjunction with the accompanying drawings, of which:

FIG. 1 is a diagram schematically illustrating a heat recovery apparatus in a fuel cell system, according to an exemplary embodiment;

FIG. 2 is a diagram schematically illustrating a fuel cell system including the heat recovery apparatus of FIG. 1, according to an exemplary embodiment; and

FIG. 3 is a flowchart of a heat recovery method according to an exemplary embodiment.

### DETAILED DESCRIPTION OF THE EXEMPLARY EMBODIMENTS

Reference will now be made in detail to the exemplary embodiments of the present teachings, examples of which are illustrated in the accompanying drawings, wherein like reference numerals refer to the like elements throughout. The exemplary embodiments are described below, in order to explain the aspects of the present teachings, by referring to the figures.

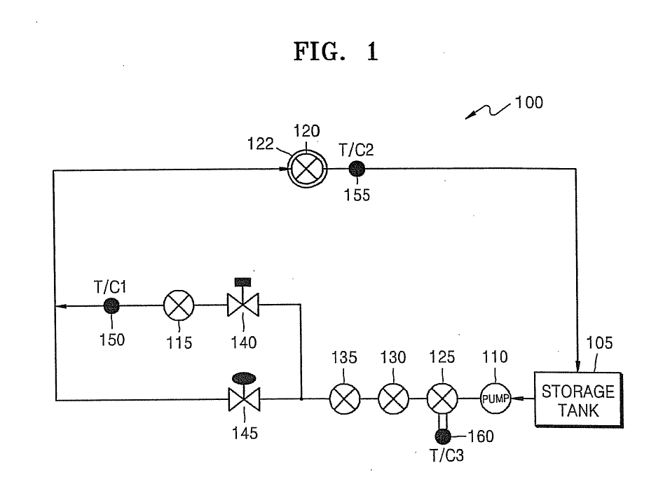

FIG. 1 is a diagram schematically illustrating a heat recovery apparatus 100 of a fuel cell system, according to an exemplary embodiment of the present teachings. The heat recovery apparatus 100 includes a storage tank 105, a pump 110, a first heat exchanger 115, a second heat exchanger 120, a third heat exchanger 125, a fourth heat exchanger 130, a fifth heat exchanger 135, an electronic valve 140, a proportionate valve 145, an electric heater 122, a first thermocouple 150, a second thermocouple 155, and a third thermocouple 160.

Heated water is stored in the storage tank 105, and the pump 110 pumps the heated water from the storage tank 105 to the third heat exchanger 125. The third thermocouple 160 measures the temperature of the third heat exchanger 125 and is installed in the third heat exchanger 125. Since the third heat exchanger 125, the fourth heat exchanger 130, and the fifth heat exchanger 135 are sequentially connected to each other, in the stated order, the water supplied to the third heat exchanger 125 is discharged via the fourth heat exchanger 130 and the fifth heat exchanger 135. Water is discharged from the fifth heat exchanger 135 and flows along first and second pipes. The proportionate valve 145 is installed in the first pipe, and the electronic valve 140 is installed in the second pipe. The first heat exchanger 115 and the first thermocouple 150 are connected to the second pipe.

The flow of water to the first heat exchanger 115 may be controlled by the electronic valve 140, and the flow of water to the second heat exchanger 120 may be controlled by the proportionate valve 145. Also, since the first thermocouple 150 is disposed at an outlet of the first heat exchanger 115, the first thermocouple 150 is able to measure the temperature of water output from the first heat exchanger 115. The first and second pipes are combined and connect to the second heat exchanger 120. The second thermocouple 155 is installed at an outlet of the second heat exchanger 120. Accordingly, the second thermocouple 155 is able to measure temperature of water output from the second heat exchanger 120. While the first through fifth heat exchangers 115-135 are disposed as illustrated in FIG. 1, the present teachings are not limited thereto.

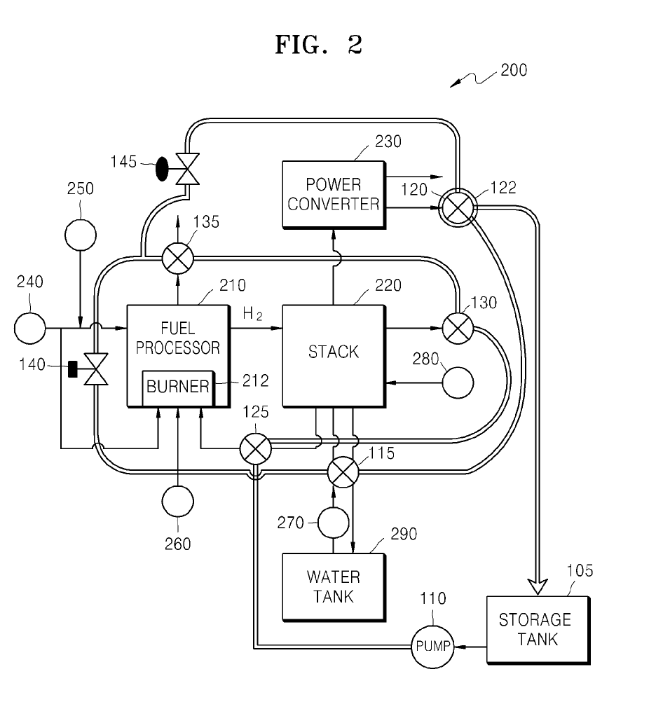

FIG. 2 is a diagram schematically illustrating a fuel cell system 200 including the heat recovery apparatus 100 of FIG. 1, according to an exemplary embodiment. The fuel cell system 200 will now be described with reference to FIGS. 1 and 2.

In addition to including the heat recovery apparatus 100, the fuel cell system 200 also includes a fuel processor 210, a stack 220, and a power converter 230. In the fuel cell system 200, the flow of gas and water for generating electricity is displayed with a single line, and the flow of water for recovering heat generated in the fuel cell system 200 is displayed with a double line.

When a hydrocarbon-based fuel gas and water are supplied to the fuel processor 210, via a fuel pump 240 and a first water pump 250, the fuel processor 210 reforms the supplied fuel gas using the water. A burner 212 attached to the fuel processor 210 heats the fuel processor 210, using the fuel gas supplied via a fuel pump 240, air supplied via a first air pump 260, and gas recovered from the stack 220. A reforming reaction in the fuel processor 210 generates hydrogen gas, which is supplied to the stack 220. The stack 220 generates a direct current (DC) using the hydrogen gas. The DC is supplied to the power converter 230, and the power converter 230 converts the DC into an alternating current (AC). Water stored in a water tank 290 is supplied to the stack 220, via a second water pump 270, in order to cool the stack 220. The water is then returned to the water tank 290.

When a natural convection phenomenon, involving the use of a thermosiphon, is used to cool the stack 220, heat may be recovered from the water tank 290, without using the second water pump 270. Alternatively, a stack cooling method using oil may be used. A second air pump 280 supplies air (oxygen) to the stack 220. When the fuel cell system 200 operates as above, heat is continuously generated. Accordingly, the fuel cell system 200 includes a plurality of heat exchangers to remove and recover the heat generated in the fuel cell system 200. The heat exchangers of FIG. 2 correspond to the first through fifth heat exchangers 115-135 of FIG. 1. The first through fifth heat exchangers 115-135 are used to recover heat generated by the fuel cell system 200.

The first heat exchanger 115 cools the stack 220 using cooling water from the water tank 290. The first heat exchanger 115 extracts heat from the cooling water discharged from the stack 220. The second heat exchanger 120 recovers heat from the electric heater 122, which uses surplus power generated by the fuel cell system 200 to generate the heat. The third heat exchanger 125 recovers heat from an anode-off gas discharged from the stack 220 and performs a gas-liquid separation on the anode off-gas. The fourth heat exchanger 130 recovers heat from air discharged from the stack 220. The fifth heat exchanger 135 recovers heat from exhaust gas discharged from the fuel processor 210.

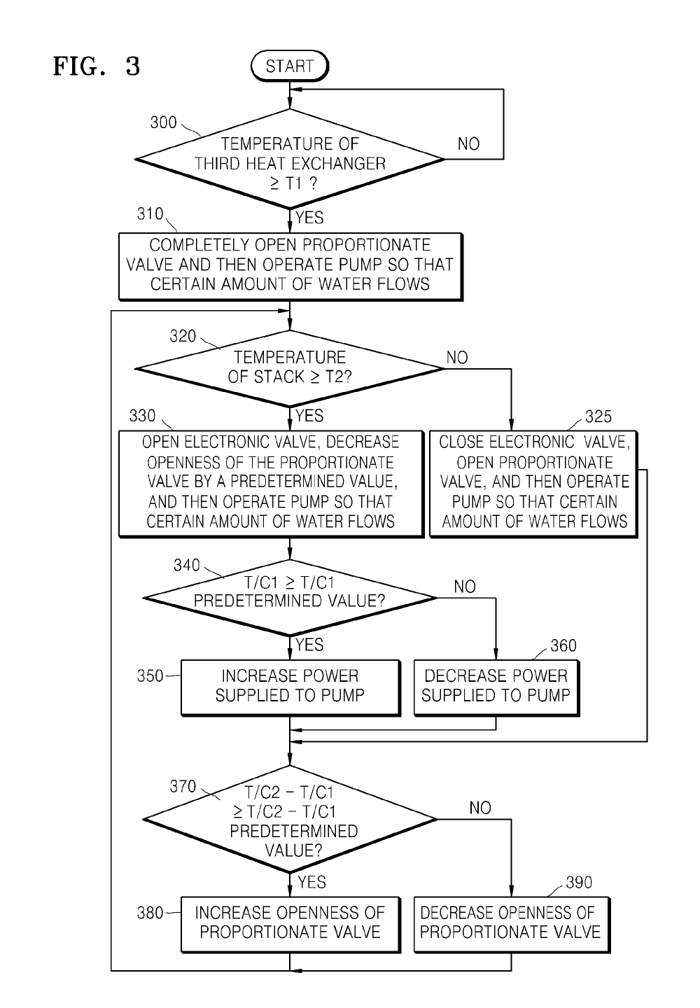

FIG. 3 is a flowchart of a heat recovery method, according to an exemplary embodiment. The heat recovery method will now be described with reference to FIGS. 1 through 3.

In operation 300, it is determined whether the temperature of the third heat exchanger 125 is at least a temperature T1. The temperature of the third heat exchanger 125 is detected using the third thermocouple 160, which is attached to the third heat exchanger 125. When the temperature of the third heat exchanger 125 is at least the temperature T1, operation 310 is performed. Otherwise, operation 300 is repeated until the temperature of the third heat exchanger 125 is at least the temperature T1.

In operation 310, the proportionate valve 145 is completely opened. After opening the proportionate valve 145, water stored in the storage tank 105 is supplied to the third heat exchanger 125, the fourth heat exchanger 130, the fifth heat exchanger 125, and then the second heat exchanger 120, via the pump 110.

In operation 320, it is determined whether the temperature of the stack 220 is at least a temperature T2. Here, the temperature T2 is a standard operating temperature of the stack 220. The temperature T2 is determined based on an operating load of the fuel cell system 200 and may vary. If the temperature of the stack 220 is at least the temperature T2, operation 330 is performed; otherwise, operation 325 is performed.

In operation 325, the electronic valve 140 is closed, the proportionate valve 145 is opened, and the pump 110 is operated, so that a certain amount of water flows. The proportionate valve 145 is completely opened, and power is supplied to the pump 110, such that a predetermined flow of water is supplied from the storage tank 105 to the third heat exchanger 125. In FIGS. 1 and 2, when the electronic valve 140 is closed and the proportionate valve 145 is opened, water flows from the fifth heat exchanger 135 to the storage tank 105, via the second heat exchanger 120.

In operation 330, the electronic valve 140 is opened, the proportionate valve 145 partially closed, and power is supplied to the pump 110, so that a predetermined flow of water is supplied from the storage tank 105 to the third heat exchanger 125. In FIGS. 1 and 2, when the electronic valve 140 is opened and the proportionate valve 145 is closed, water flows from the fifth heat exchanger 135 to the second heat exchanger 120, via the first heat exchanger 115.

In operation 340, the temperature of water discharged from the first heat exchanger 115 is compared with a temperature T/C1. If the temperature of the first thermocouple 150 is at least the temperature T/C1, operation 350 is performed; otherwise, operation 360 is performed.

In operation 350, the power supplied to the pump 110 is increased, to increase the flow of water supplied to the first heat exchanger 115. By increasing the flow of water supplied to the first heat exchanger 115, the heat recovery efficiency of the stack 220 is increased. In operation 360, the power supplied to the pump 110 is decreased, to decrease the flow of water supplied to the first heat exchanger 115.

In operation 370, a difference between the temperature of water discharged from the first heat exchanger 115 and the temperature of water discharged from the second heat exchanger 120 is determined. The determined temperature difference is compared to a predetermined temperature difference, to determine whether the temperature difference is at least equal to the predetermined temperature difference. Here, the predetermined temperature difference is a difference that is sufficient to recover heat from the second heat exchanger 120, which is used to recover heat generated by the electric heater 122. If a difference between a temperature T/C2 of the second thermocouple 155 and the temperature T/C1 of the first thermocouple 150 is at least the predetermined difference, operation 380 is performed; otherwise, operation 390 is performed.

In operation 380, the proportionate valve 145 is partially opened, to increase the flow of water supplied to the second heat exchanger 120. In operation 390, the proportionate valve 145 is partially closed, to reduce, the flow of water supplied to the second heat exchanger 120.

Various exemplary embodiments may be written as computer programs and may be implemented in general-use digital computers that execute the programs using a computer readable recording medium. A data structure used in the exemplary embodiments may be recorded on the computer readable recording medium, using various devices and methods. Examples of the computer readable recording medium include magnetic storage media (e.g., ROM, floppy disks, hard disks, etc.), optical recording media (e.g., CD-ROMs, or DVDs), and storage media.

Although a few exemplary embodiments of the present teachings have been shown and described, it would be appreciated by those skilled in the art that changes may be made in these exemplary embodiments, without departing from the principles and spirit of the invention, the scope of which is defined in the claims and their equivalents.

What is claimed is:

1. A heat recovery apparatus of a fuel cell system comprising a fuel processor, a stack, and a power converter, the heat recovery apparatus comprising:
a storage tank that stores water heated by the fuel cell system;
a pump that pumps the water from the storage tank;
a first heat exchanger that recovers heat from water used to cool the stack;
a second heat exchanger that recovers heat from an electric heater that uses surplus power generated by the fuel cell system;
a third heat exchanger that recovers heat from an anode-off gas discharged from the stack and separates liquids from the anode-off gas;
a fourth heat exchanger that recovers heat from air discharged from the stack;
a fifth heat exchanger that recovers heat from an exhaust gas discharged from the fuel processor;
an electronic valve that controls water flow to the first heat exchanger;
a proportionate valve that controls water flow to the second heat exchanger;
a first thermocouple that measures the temperature of water output from the first heat exchanger;
a second thermocouple that measures the temperature of water output from the second heat exchanger; and
a third thermocouple that measures the temperature of the third heat exchanger.

2. The heat recovery apparatus of claim 1, wherein the water pumped from the storage tank:
flows sequentially through the third-fifth heat exchangers;
flows from the fifth heat exchanger, through the proportionate valve, to the second heat exchanger; and
flows from the fifth heat exchanger, through the electronic valve and the first heat exchanger, to the second heat exchanger.

3. The heat recovery apparatus of claim 2, wherein when the temperature of the third thermocouple is at least a certain temperature, the electronic valve is closed and the proportionate valve is completely opened.

4. The heat recovery apparatus of claim 2, wherein when the temperature of the stack is above a predetermined temperature, the electronic valve is opened.

5. The heat recovery apparatus of claim 2, wherein when the temperature of the first thermocouple is above a predetermined temperature, the water flow to the first heat exchanger is increased, by increasing power supplied to the pump, and
when the temperature of the first thermocouple is below the predetermined temperature, the water flow to the first heat exchanger is decreased, by decreasing power supplied to the pump.

6. The heat recovery apparatus of claim 2, wherein when a difference between the temperature of the second thermocouple and the temperature of the first thermocouple is at least equal to a predetermined value, the proportionate valve is partially opened, and
when the difference is less than the predetermined value, the proportionate valve is partially closed.

7. A fuel cell system comprising:
a fuel processor that reforms a fuel gas into a reformate gas;
a stack that generates a direct current (DC) using the reformate gas;
a power converter that converts the DC into an alternating current (AC); and
a heat recovery apparatus comprising:
a storage tank that stores water heated by the fuel cell system;
a pump that pumps the water from the storage tank;
a first heat exchanger that recovers heat from cooling water discharged from the stack;
a second heat exchanger that recovers heat from an electric heater that uses surplus power generated by the fuel cell system;
a third heat exchanger that recovers heat from an anode-off gas discharged from the stack and separates liquid from the anode-off gas;
a fourth heat exchanger that recovers heat from air discharged from the stack;
a fifth heat exchanger that recovers heat from exhaust gas discharged from the fuel processor;
an electronic valve that controls water flow to the first heat exchanger;
a proportionate valve that controls water flow to the second heat exchanger;
a first thermocouple that measures the temperature of water output from the first heat exchanger;
a second thermocouple that measures the temperature of water output from the second heat exchanger; and
a third thermocouple that measures the temperature of the third heat exchanger.

8. A heat recovery method of a fuel cell system comprising a fuel processor, a stack, and a power converter, the heat recovery method comprising:
determining whether the fuel cell system is completely activated;
if the fuel cell system is completely activated, closing an electronic valve and completely opening a proportionate valve, in order to control water flow to a second heat exchanger that recovers heat from an electric heater that uses surplus power generated by the fuel cell system;
supplying cooling water to the stack and opening the electronic valve that controls water flow to a first heat exchanger that recovers heat from the cooling water; and
supplying a predetermined amount of water to the first heat exchanger.

9. The heat recovery method of claim 8, further comprising opening the electronic valve to control the water flow to the first heat exchanger, when the temperature of the stack is at least a certain temperature.

10. The heat recovery method of claim 8, further comprising:
increasing the water flow to the first heat exchanger, by increasing power supplied to the pump, if a measured temperature of water discharged from the first heat exchanger is greater than or equal to a predetermined temperature; and
decreasing the water flow to the first heat exchanger, by decreasing the power supplied to the pump, if the measured temperature is below the predetermined temperature.

11. The heat recovery method of claim 8, further comprising:
measuring a difference between the temperature of water discharged from the second heat exchanger and the temperature of water discharged from the first heat exchanger, in order to control the flow of water to the second heat exchanger, which recovers heat from the electric heater;
increasing the water flow to the second heat exchanger, by partially opening the proportionate valve, if the measured difference is greater than or equal to a predetermined temperature difference; and
decreasing the water flow to the second heat exchanger, by partially closing the proportionate valve, if the measured difference is less than the predetermined temperature difference.
